(19) United States
(12) Patent Application Publication
(10) Pub. No.: US 2009/0004524 A1
(43) Pub. Date: Jan. 1, 2009

(54) FUEL CELL

(75) Inventors: Cheng Wang, Hsinchu (TW); Jin-Shu Huang, Hsinchu (TW); Ching-Po Lee, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/924,616

(22) Filed: Oct. 26, 2007

(30) Foreign Application Priority Data
Jun. 28, 2007 (TW) 96123505

(51) Int. Cl. H01M 8/10; H01M 8/04

(52) U.S. Cl. 429/30; 429/39

(57) ABSTRACT

A fuel cell including at least a fuel cell module is provided. The fuel cell module has a membrane electrode assembly (MEA), two base plates, an anode current collector and a cathode current collector. The two base plates are disposed on two opposite sides of the MEA to clamp the edge of the MEA. The anode current collector and the cathode current collector are respectively assembled in the central area of the MEA. Moreover, the cathode current collector protrudes from the corresponding base plate. Water produced by the cathode in the present invention flows out through the edge of the cathode current collector so as to improve electricity generation efficiency.

### CROSS-REFERENCE TO RELATED APPLICATION

This application claims the priority benefit of Taiwan application serial no. 96123505, filed on Jun. 28, 2007. All disclosure of the Taiwan application is incorporated herein by reference.

### BACKGROUND OF THE INVENTION

1. Field of the Invention

The present invention generally relates to a battery and module thereof, and more particularly, to a fuel cell.

2. Description of Related Art

The consumption of conventional energy sources such as coal, oil and natural gas continues to increase despite continuous increase in efficiency through advancement of technologies. Because the reserve of these natural resources is limited, countries all over the world are making efforts to find alternative energy sources for replacing the conventional energy sources. Fuel cell is an important choice, which has practical value.

FIG. 1A shows a structure of a conventional stacked fuel cell module. As shown in FIG. 1A, the fuel cell module 100 includes a membrane electrode assembly (MEA) 110, an anode current collector 120a and a cathode current collector 120b. The material forming the anode current collector 120a and the cathode current collector 120b includes graphite. Besides, one side of the anode current collector 120a and the cathode current collector have a plurality of grooves etched thereon serving respectively as an anode flow channel 122a and a cathode flow channel 122b. The anode flow channel 122a and the cathode flow channel 122b are respectively used for transporting anode reactant (methanol solution) and cathode reactant (oxygen or air). In actual applications, fuel cell modules 100 are stacked to produce a higher power output.

The foregoing fuel cell has some drawbacks that might affect the power generation efficiency and production cost of the fuel cell. For example, the cathode of the fuel cell produces water in the chemical reaction process. When water accumulates around the cathode, reaction at the cathode is blocked so as to reduce the power generation efficiency of the fuel cell. To resolve the water accumulation problem at the cathode, a gas pump (not shown) is normally used to pump air (or oxygen) into the cathode flow channel so as to supply the reactant for the reaction at the cathode. At the same time, the water produced by the reaction at the cathode is also driven away from the fuel cell to achieve water drainage. However, the gas pump not only generates loud noise, but also consumes considerable power. Therefore, gas pump is unsuitable for a portable product. Moreover, the gas pump has a relatively shorter service life so as to increase overall cost of the fuel cell is.

To prevent reactants for the cathode and anode of the fuel cell from leaking and make the gas pump produce enough pressure for supplying the cathode flow channel, each component of the fuel cell, in particular, the cathode current collector and the membrane electrode assembly, must be tightly pressed so as to prevent a gas or liquid leak from causing adverse effect, for example, a lowering of the power generation efficiency of the fuel cell. The conventional method of assembling the components of a fuel cell utilizes the substantially larger area of the anode current collector and the cathode current collect with respect to the membrane electrode assembly. Besides, two end plates are added to the outside of the anode current collector and the cathode current collector, and then a plurality of screws is used to lock up the end plates to the surrounding area in order that the two end plates are tightly pressed against the fuel cell. However, the press method of the assembling causes the membrane electrode assembly to receive different amount of compression in different places in order that internal resistance of the membrane electrode assembly and its power generation capacity are affected. As a result, the service life of the fuel cell is shortened. Besides, in the press assembling process, the graphite current collectors are frequently broken so as to increase the production cost. Although that metal plates are used as the current collectors solves the broken graphite problem, the metal plates are much heavier and have a material corrosion problem.

FIG. 1B is a perspective view of a conventional planar stacked fuel cell. The planar stacked fuel cell 130 mainly includes a plurality of fuel cell modules 132 and a fan 134. On a sheet of fuel cell module 132, a plurality of membrane electrode assemblies is disposed on the same plane, and a cathode current collector 136 is disposed outside of each membrane electrode assembly. The conventional cathode current collector is a metal wire knitted mesh (as shown in FIG. 1C), a metal plate with punched holes (as shown in FIG. 1D), or a current collector that uses circuit board material FR4 as the based material substrate and having a gold-plated surface with multiple holes (as shown in FIG. 1E). Because the foregoing cathode current collectors are made from flexible material, the cathode current collectors may deform in the press assembling process and lead to a higher ohmic resistance (internal resistance) of the fuel cell modules. Consequently, overall electricity generation efficiency of the fuel cell may be lowered.

The planar stacked fuel cell 130 drains water by using a fan 134 having a longer service life, instead of a gas pump. However, the wind pressure produced by the fan is lower than the wind pressure produced by the gas pump in order that the drainage effect is inferior. Besides, in order to make the air flow provided by the fan have a larger contact area with the cathode catalyst layer inside the membrane electrode assembly, the cathode current collector needs to have a larger aperture ratio. Yet, a larger aperture ratio reduces the strength of the cathode current collector structure. In addition, in order to make the air flow provided by the fan distribute evenly across every location on the surface of the cathode catalyst layer, the fan required to be used together with a wave-like cathode flow channel plate. Although the wave-like cathode flow channel plate somewhat compensates for the lack of strength of the cathode current collector to withstand the press assembling process, the defect of the wave-like cathode flow channel plate is the occupation of a larger volume in order that overall volume of the fuel cell may become too large.

Besides, in U.S. Pat. No. 5,856,035, a solid oxide fuel cell module structure is disclosed. FIG. 1F is an exploded diagram of a solid oxide fuel cell module structure. As shown in FIG. 1F, the solid oxide fuel cell module 10 includes, in sequence from bottom to top, a groove structure 42, a unidirectional flow end connection 24, a cathode 14, a conducting bipolar plate 16, another cathode 14, a unidirectional flow end connection 26 and another groove structure 40. Although the product produced by the cathode of the solid oxide fuel cell module 10 is not a liquid in order that liquid flooding does not occur, the patented structure still cannot resolve the aforementioned problems.

Additionally, heat is normally directly applied to the anode reactant or the fuel cell stack so as to increase electricity generation efficiency when the fuel cell is cold started. Although such pre-heating is capable of increasing the power output of the fuel cell, the additional electrical power that needs to be consumed lowers the real economic value.

### SUMMARY OF THE INVENTION

Accordingly, the present invention provides a fuel cell capable of resolving water accumulation, uneven compression and other related problems in order that the electricity generation efficiency of the fuel cell is maintained and the service life of the fuel cell is increased.

Other purposes and advantages of the present invention can be better realized through the technical features as disclosed herein.

To achieve part of or all the purposes or other purposes of the present invention, an embodiment of the present invention provides a fuel cell, and the fuel cell includes at least a fuel cell module. The fuel cell module includes a membrane electrode assembly (MEA), a first base plate, a second base plate, an anode current collector and a cathode current collector. The first base plate has a first opening, and the first base plate is disposed on a first side of the MEA. The first opening exposes a central area of the first side of the MEA. The second base plate has a second opening, and the second base plate is disposed on a second side of the MEA. The second opening exposes a central area of the second side of the membrane electrode assembly. The first base plate and the second base plate are disposed on two opposite sides of the MEA to clamp the first side and the second side of the MEA. The anode current collector is disposed on the second side of the MEA to cover the central area of the second side of the MEA. The cathode current collector is disposed on the first side of the MEA and assembled to the first base plate to cover the central area of the first side of the MEA. Besides, the cathode current collector extends into the first opening and a plurality of flow channels is formed between the cathode current collector and the MEA.

In the present invention, the cathode current collector protrudes from the corresponding base plate and the side edge of the cathode current collector exposes at least a portion of the flow channel. Therefore, the water produced by the cathode flows out from the edge of the cathode current collector without being accumulated in the cathode catalyst layer in order that the electricity generation efficiency of the fuel cell is maintained. In other words, the edge of the cathode current collector permits the input and output of air. Besides, in the press assembling process of the fuel cell, the amount of compression may be evenly spread over the MEA in order that the internal resistance of the MEA and its electricity generation capacity are not adversely affected and the service life of the fuel cell is increased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is diagram showing a structure of a conventional stacked fuel cell module.

FIG. 1B is a perspective view of a conventional planar stacked fuel cell.

FIGS. 1C, 1D and 1E are diagrams showing a few of conventional cathode current collectors.

FIG. 1F is a dissembled diagram of a solid oxide fuel cell module structure.

FIG. 2A is a diagram showing a structure of a fuel cell module according to an embodiment of the present invention.

FIG. 2B is a diagram showing a structure of another fuel cell module according to an embodiment of the present invention.

FIGS. 3, 4, 5A and 6 are diagrams showing a few structural variations of cathode current collector according to an embodiment of the present invention.

FIG. 5B is a diagram showing a structure of a fuel cell module having a plurality of cathode current collectors disposed thereon according to an embodiment of the present invention.

FIG. 7 and FIG. 8 are diagrams showing various structures of cathode current collector according to an embodiment of the present invention.

FIG. 9 is a diagram showing a structure of another fuel cell according to an embodiment of the present invention.

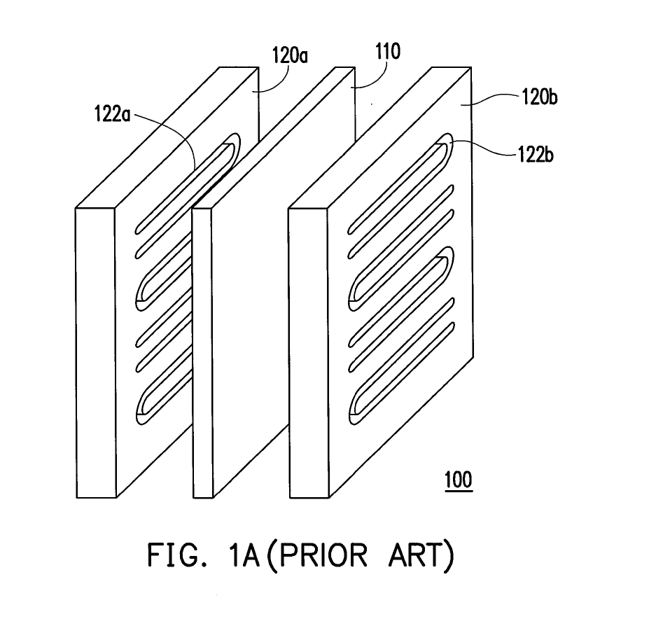

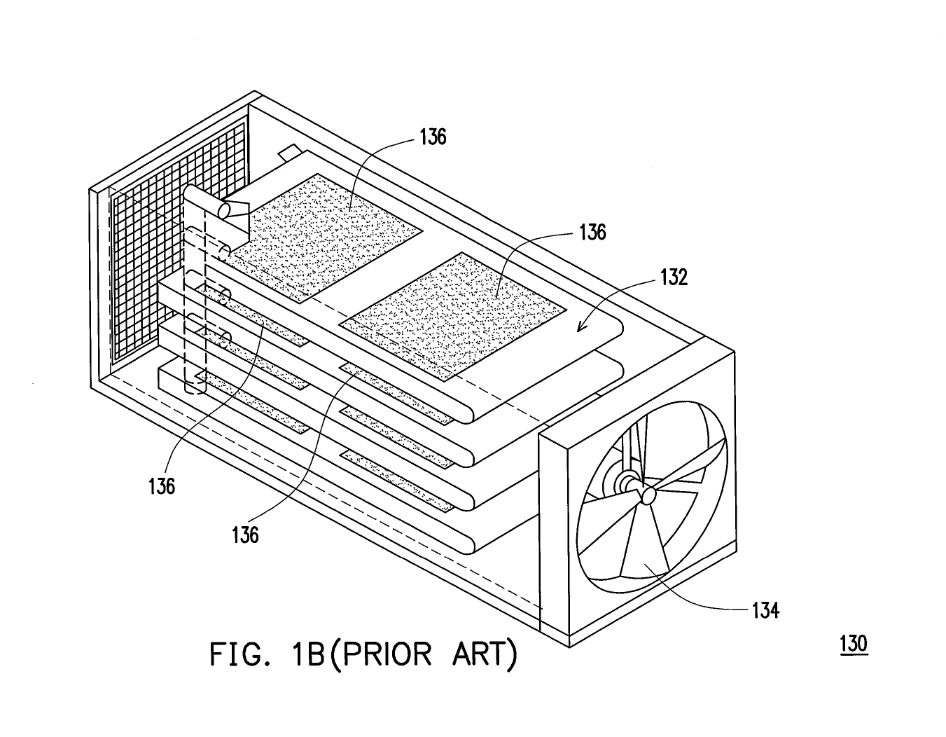

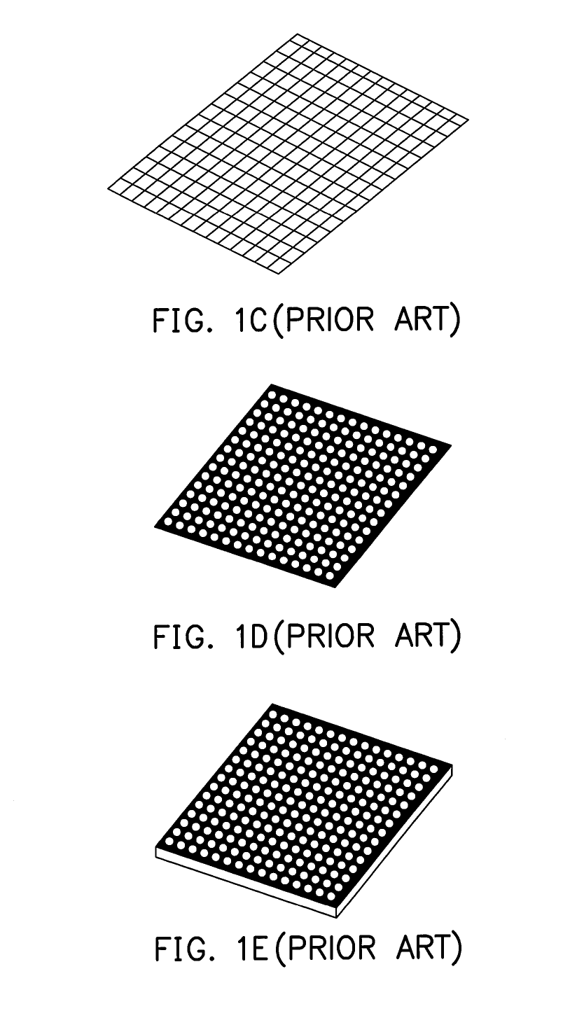

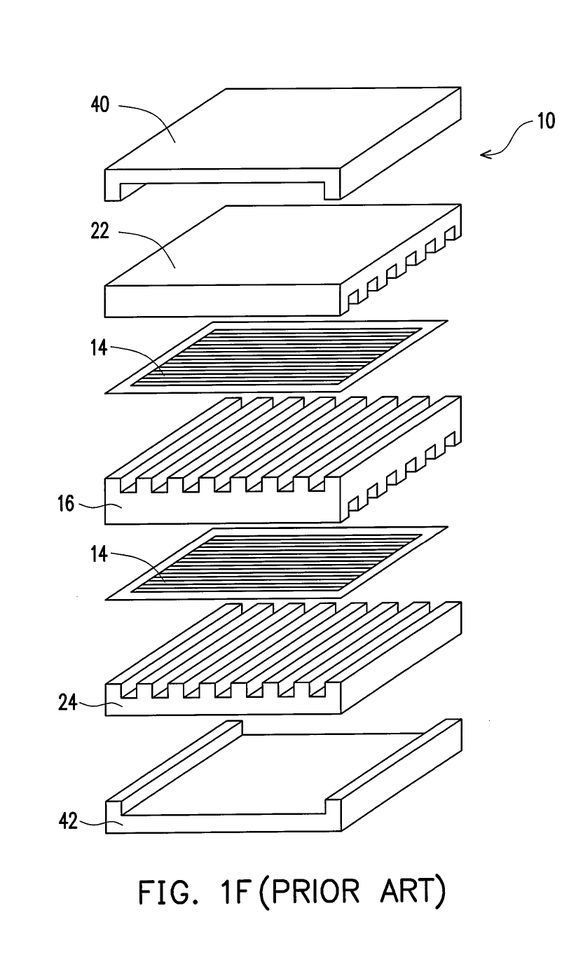

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

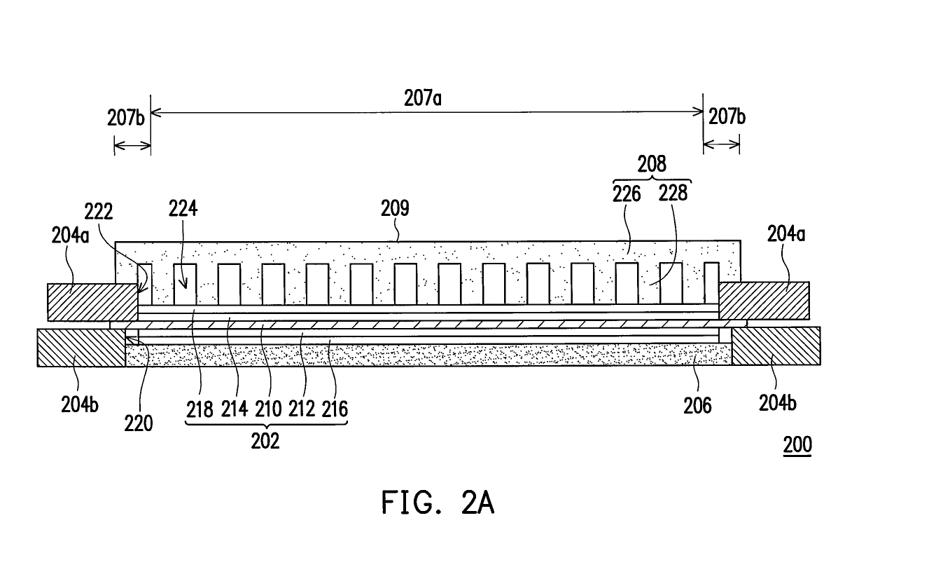

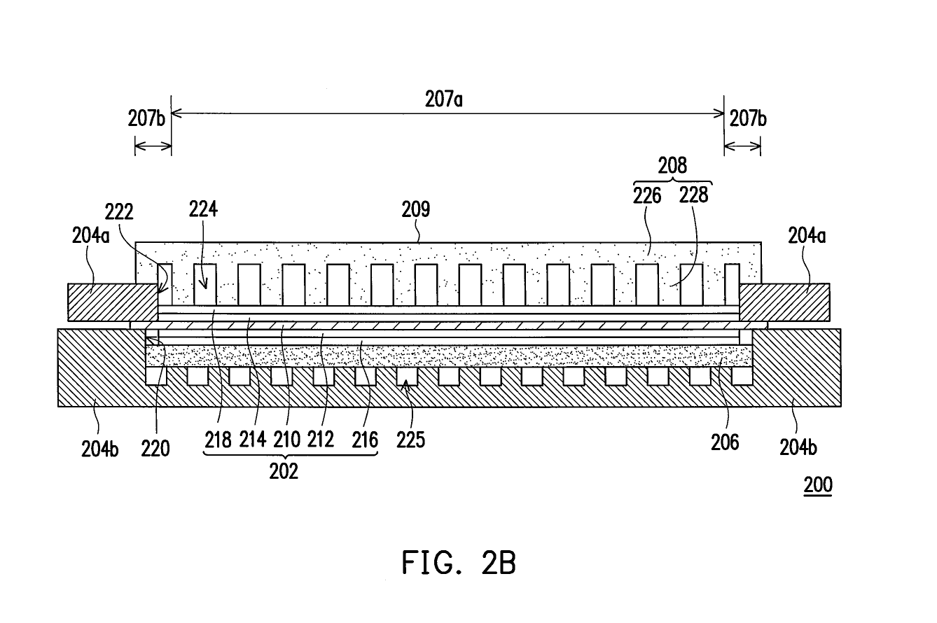

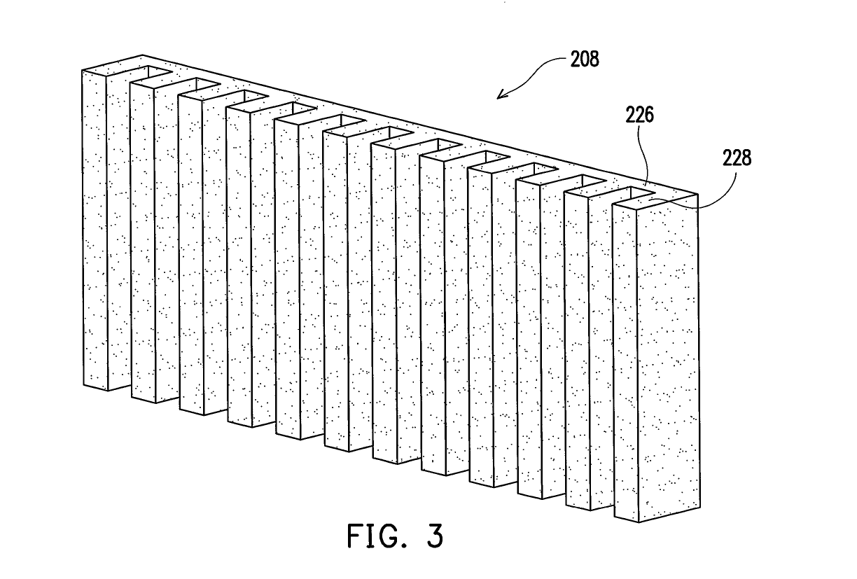

The fuel cell in the present embodiment includes at least one fuel cell module. In FIG. 2A and FIG. 2B, a fuel cell having just one fuel cell module is used as an example. FIG. 2A is a diagram showing the structure of a fuel cell module according to an embodiment of the present invention. FIG. 3 is a diagram showing part of the structure of a cathode current collector according to an embodiment of the present invention.

As shown in FIG. 2A, the fuel cell module 200 includes a membrane electrode assembly (MEA) 202, a first base plate 204a, a second base plate 204b, an anode current collector 206 and a cathode current collector 208. The MEA 202 includes, for example, a proton exchange membrane 210, an anode catalyst layer 212, a cathode catalyst layer 214, an anode diffusion layer 216 and a cathode diffusion layer 218. The anode catalyst layer 212 is disposed on one side of the proton exchange membrane 210, and the cathode catalyst layer 214 is disposed on another side of the proton exchange membrane 210. The anode diffusion layer 216 is disposed on the anode catalyst layer 212, and the cathode diffusion layer 218 is disposed on the cathode catalyst layer 214. Besides, the anode diffusion layer 216 and the cathode diffusion layer 218 may be fabricated by using, for example, carbon fiber cloth whose surfaces are coated with about 30% of hydrophilic poly-tetra-fluoro-ethylene (PTFE). Therefore, water drainage is facilitated and the lowering of the output power due to the accumulation of water is prevented.

The first base plate 204a is disposed on a first side of the MEA 202. The first base plate 204a has a first opening 222, and the first opening 222 exposes a central area of the first side of the MEA 202. The second base plate 204b is disposed on a second side of the MEA 202 opposite to the first side. The first base plate 204a and the second base plate 204b are used to clamp the first side and the second side of the MEA 202. In the present embodiment, the second base plate 204b has a second opening 220, and the second opening 220 also exposes a central area of the second side of the MEA 202. The first base plate 204a and the second base plate 204b may be fabricated using an organic glass fiber plate, for example. The material of the organic fiber plate includes FR4, FR5 or other suitable types of organic glass fibers. The first base plate 204a, the second base plate 204b and the MEA 202 may be joined together using adhesive glue made from epoxy resin mixed with glass fibers. Moreover, the first base plate 204a and the second base plate 204b may be fabricated, for example, by directly curing adhesive glue made from epoxy resin mixed with glass fibers. The material of the first base plate 204a and the second base plate 204b may be epoxy resin, for example. Besides, the first base plate 204a and the second base plate 204b may also be fabricated using a plastic base plate having a definite strength and high chemical resistance, for example. The first base plate 204a and the second base plate 204b may be fabricated using a stack production process, a similar concept for fabricating a built-up circuit board. The anode current collector 206 is disposed on the second side of the MEA 202 so as to cover the central area of the second side of the MEA 202.

In another embodiment as shown in FIG. 2B, the second base plate 204b may also be an anode flow channel plate made of plastic material, and the anode current collector 206 may be fixed on the anode flow channel plate. At this time, a structure between the anode flow channel plate and the anode current collector allows anode reactant to flow in and out. The above structure is, for example, a set of holes 225 that allows anode reactant (for example, methanol) to enter or leave.

In addition, the cathode current collector 208 of the fuel cell module 200 of the present embodiment is disposed on the first side of the MEA 202 and assembled to the first base plate 204a to cover the central area of the first side of the MEA 202, and the cathode current collector 208 extends into the first opening 222. The cathode current collector 208 has a press area 207a located on the first side of the MEA 202 and a fixed area 207b located at two sides of the press area 207a. The cathode current collector 208 is formed using a conductive material that is not so easily deformed or warped, and the material of the conductive material is SUS316L or other type of stainless steel, for example. In an embodiment, a metal with superior conductivity such as copper (Cu) or gold (Au) may be plated on a surface 209 of the cathode current collector 208 away from the MEA 202 so as to enhance electrical conductivity. Moreover, in order to provide the cathode current collector 208 with better chemical resistance, an insulating material layer such as Teflon or chemical resistant plastic material may be coated on the metal layer after plating the highly conductive metal on the surface 209 of the cathode current collector 208. Specifically, The conducting material layer is located between the insulating material layer and the cathode current collector 208. In particular, the cathode current collector 208 protrudes from the corresponding first base plate 204a, and a plurality of flow channels 224 is formed between the cathode current collector 208 and the MEA 202. Besides, the area of the press area 207a of the cathode current collector 208 is smaller than the area of the MEA 202, and the side edges of the cathode current collector 208 expose at least a portion of the flow channel 224.

Therefore, when the fan is used to provide air (or oxygen) to the cathode for reaction, the air (or oxygen) easily finds its way through the flow channels 224 and water produced by the reaction in the cathode is removed. Moreover, if the moisture produced by the cathode exceeds the rate of removal in order that the moisture condenses into water, then the condensed water is easily drained away through the flow channels 224 surrounding the cathode current collector 208 under the action of gravity. In other embodiment, a hydrophilic/hydrophobic treatment of the surface 209 of the cathode current collector 208 may be performed in order that water in the cathode easily flows out from the cathode current collector 208. Alternatively, the surface 209 of the cathode current collector 208 is an inclined surface, for example, in order that water in the cathode flow outs along the inclined surface. Or, alternatively, the surface 209 of the cathode current collector 208 has water-guiding micro-trench pattern or knitted water-absorbing net structure in order that water in the cathode flows out through the microstructures. Therefore, water flows out from the cathode through the flow channels 224 surrounding the cathode current collector 208 in order that flooding of the water does not occur and the electricity generation efficiency of the fuel cell is maintained. Besides, the need of the conventional cathode flow channel plate used for evenly distributing airflow to the MEA is eliminated. Moreover, the edges of the cathode current collector 208 also allow external air to enter or leave so as to enhance the performance of the fuel cell modules.

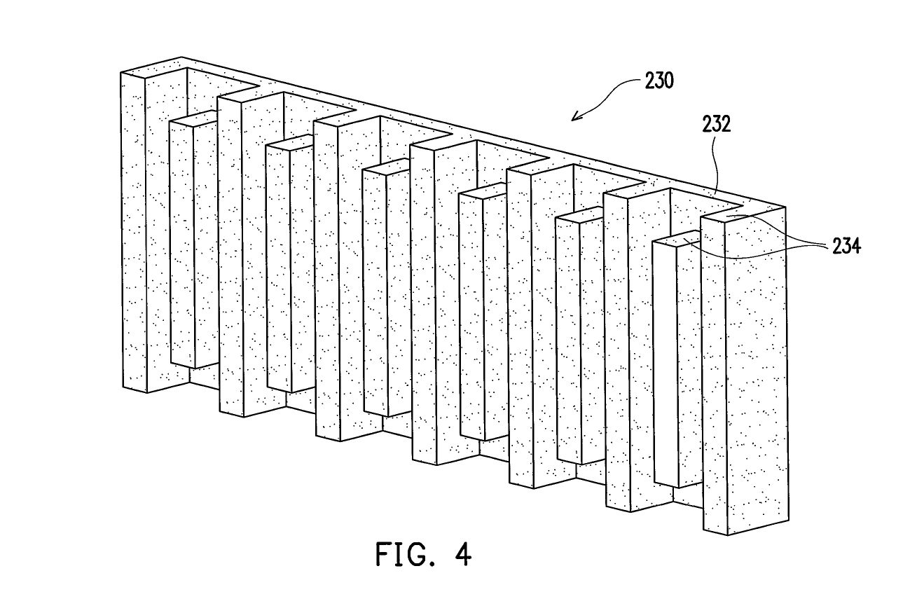

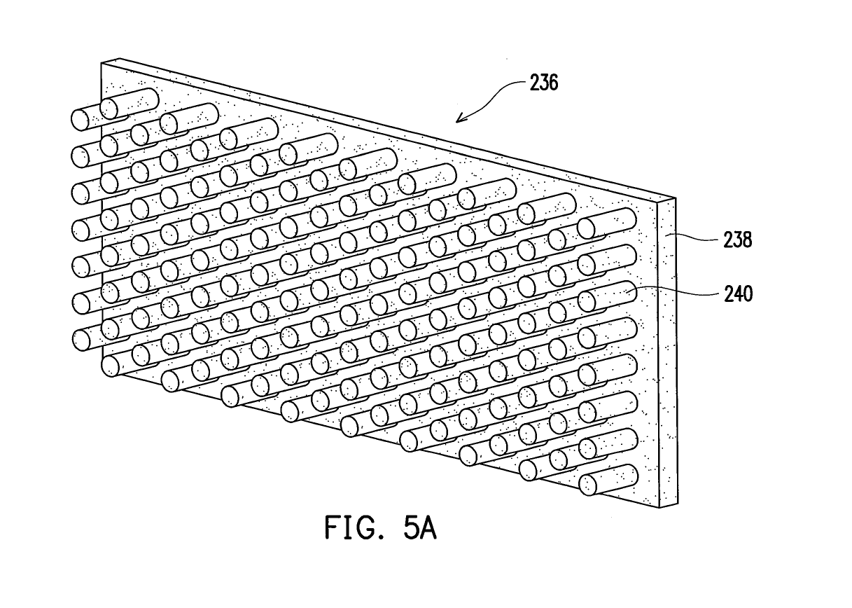

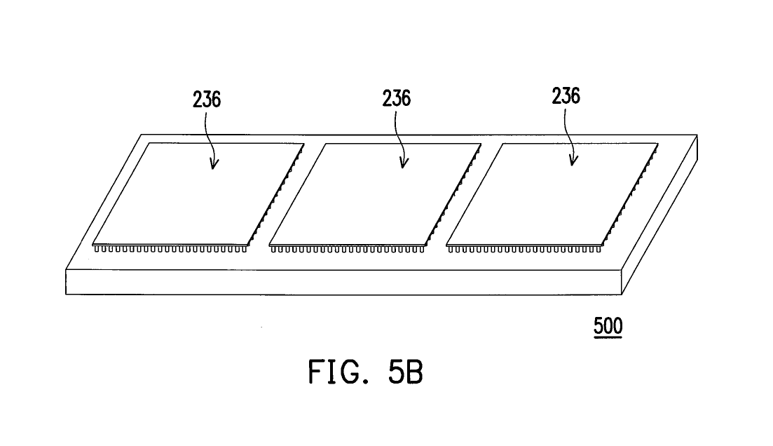

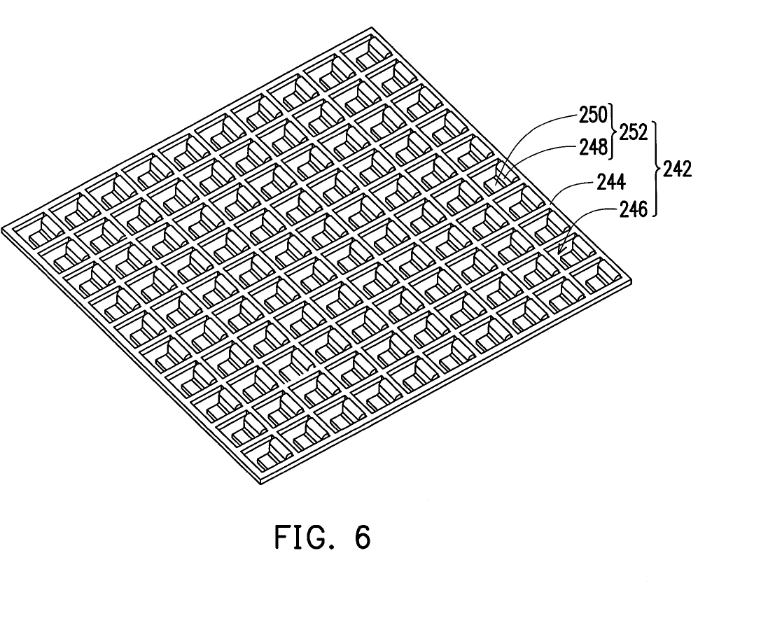

In the present embodiment, the press area and the fixed area of the cathode current collector may have an identical structure, for example. The cathode current collectors shown in FIG. 3, FIG. 4, FIG. 5A and FIG. 6 are used as examples in the following. As shown in FIG. 3, the press area 207a of the cathode current collector 208 includes a bottom plate 226 and a plurality of protruding portions 228. The protruding portions 228 are disposed on one side of the bottom plate 226. Besides, the protruding portions 226 protrude from the side of the bottom plate 226 toward the corresponding MEA 202, and the flow channels are formed between the protruding portions 228. Moreover, these protruding portions 228 may be ribs having an equal length and arranged in parallel to one another. In another embodiment, to satisfy the requirement for pressing onto the MEA, the press surfaces of the protruding portions 228 of the cathode current collector 208 may be curve surfaces. In other words, the surface of the protruding portions 228 close to the MEA may be a curve surface.

Next, as shown in FIG. 4, the cathode current collector 230 includes a bottom plate 232 and a plurality of protruding portions 234. The structure of the cathode current collector 230 is substantially identical to the structure of the cathode current collector 208 in FIG. 3. The main difference between the two is that the protruding portions 234 of the cathode current collector 230 includes ribs of two different lengths alternately disposed but arranged in parallel to one another on one side of the bottom plate 232.

Next, as shown in FIG. 5A, the cathode current collector 236 includes a bottom plate 238 and a plurality of protruding portions 240. The structure of the cathode current collector 236 is substantially identical to the structure of the cathode current collector 208 in FIG. 3. The main difference between the two is that the protruding portions 240 of the cathode current collector 236 are rods, for example, circular rods, and these rods are arranged in an array on one side of the bottom plate 238.

Next, as shown in FIG. 6, the cathode current collector 242 includes a bottom plate 244 and a plurality of protruding portions 252. The structure of the cathode current collector 242 is substantially identical to the structure of the cathode current collector 208 in FIG. 3. The main difference between the structures in FIG. 3 and FIG. 6 is shown as below. The bottom plate 244 of the cathode current collector 242 has a plurality of openings 246, and the protruding portions 252 are located at the edges of corresponding openings 246. Each of the protruding portions 252 includes a first bent plate 250 and a second bend plate 248. The first bent plate 250 is parallel to the bottom plate 244. The second bent plate 248 is connected to the first bent plate 250 and the bottom plate 244, and is perpendicular to the bottom plate 244.

The embodiment of the present invention may also dispose a plurality of cathode current collectors on the same base plate. The cathode current collector shown in FIG. 5A is used as an example. FIG. 5B is a diagram showing the structure of a fuel cell module having a plurality of cathode current collectors disposed thereon. In FIG. 5B, only the cathode current collectors are shown, and both the MEA and the anode current collectors are not shown. The fuel cell module 500 may include a plurality of cathode current collectors 236 disposed at a fixed distance on the base plate. According to FIG. 5B, the cathode current collectors 236 on the fuel cell module 500 may form open flow channels. Therefore, water flows out from the edges of the cathode current collectors and the airflow is evenly distributed.

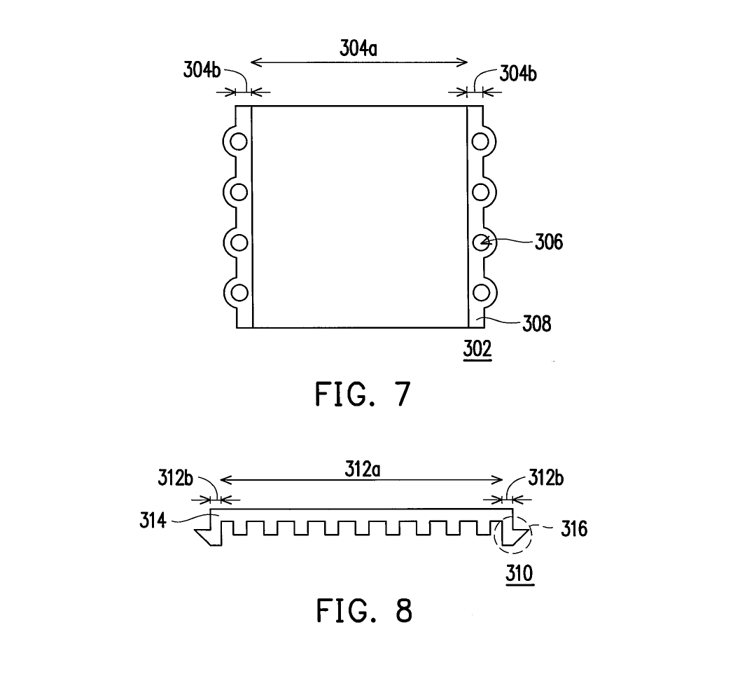

Obviously, the present invention is not intended to provide specific limitation on the structure of the cathode current collector. Besides the foregoing embodiment, the press area and the fixed area of the cathode current collector may have different structures, for example. Moreover, they may be implemented using a configuration as shown in FIG. 7 or FIG. 8.

As shown in FIG. 7, the cathode current collector 302 has a press area 304a and a fixed area 304b. The structure of the press area 304a of the cathode current collector 302 may be any one of those structures shown in FIG. 3, FIG. 4, FIG. 5A and FIG. 6 in order that a detailed description is omitted here. The fixed area 304b of the cathode current collector 302 is located at two sides of the press area 304a, and the fixed area 304a may be configured as a bottom plate 308 with a plurality of through holes 306 at intervals, for example.

As shown in FIG. 8, the cathode current collector 310 has a press area 312a and a fixed area 312b. The press area 312a may have a structure shown in FIG. 3, for example. The fixed area 312b of the cathode current collector 310 includes a second bottom plate 314 and a plurality of connecting components 316 disposed on one side of the second bottom plate 314. The connecting components 316 of the cathode current collector 310 are used for connecting with the first base plate 204a (as shown in FIG. 2A). The connecting components 316 may be latching portions such as latching hooks or latching holes, for example. In FIG. 8, the connecting components 316 are shown to be latching hooks. In addition, the structure of the press area 312a may be any one of the structures shown in FIG. 4, FIG. 5A and FIG. 6 in order that a detailed description is omitted. Next, the method of assembling the fuel cell module 200 is described with reference to FIGS. 2A and 3. To assemble the fuel cell module 200, the first base plate 204a, and the second base plate 204b may be place around the MEA 202 so as to fix the edges of the MEA 202. Thereafter, the anode current collector 206 and the cathode current collector 208 are pressed onto the central area of the MEA 202 so as to adjust the pressure on the MEA 202. Alternatively, the method of assembling the fuel cell module 200 is described with reference to FIGS. 2B and 3. The anode current collector 206 is first combined with the second base plate 204b, and then the MEA 202 is gripped between the first base plate 204a and the second base plate 204b. In the foregoing assembling methods, the cathode current collector 208 may connect the fixed area 207b to the nearby first base plate 204a or surrounding structural components by soldering, gluing, hot pressing or screw locking, or connect to the second base plate 204b or surrounding structural components by soldering, gluing, hot pressing or screw locking. On the other hand, for the cathode current collector 302 in FIG. 7, screws that pass through the through holes 306 may be used to lock the cathode current collector 302 to the first base plate 204a or the second base plate 204b. Moreover, the screws may pass through the through holes 306 and the first and second base plates 204a, 204b and then using nuts to tighten up the assembly. For the cathode current collector 302 in FIG. 8, a structure for assembling with the connecting component 316 may be disposed on the first base plate 204a in a location corresponding to the connecting component 316. For example, the connecting component 316 may be a latching hook. If a latching hook is used, the first base plate 204a and the connecting component 316 are connected by means of latching. As a consequence, residual interfacial stress between the MEA and other additional packing material such as PCB is reduced.

It should be noted that the press area of the cathode current collector in the present embodiment has an area smaller than the area of the MEA and has a 3-dimensional structure. Therefore, when press assembling the fuel cell, the amount of compression applied to the MEA is even in order that internal resistance of the membrane electrode assembly and its power generation capacity are not affected. As a result, the service life of the fuel cell is increased.

On the other hand, the cathode current collector of the present embodiment may utilize different arrangements of the protruding portions to adjust the aperture ratio so as to obtain a larger aperture ratio. Consequently, there is a larger contact area between the airflow and the cathode contact layer inside the MEA so as to increase the power output of the fuel cell.

In another embodiment, a heating plate may be disposed on the cathode current collector for heating the MEA so as to increase the electricity generation efficiency of the fuel cell. This heating plate may be a resistive heating wire or a ceramic heating panel or a nickel-chromium wire. If the heating plate is fabricated using an electrically conducting material, electrical insulation must be provided between the heating plate and the cathode current collector. More specifically, compared to the conventional technique of directly heating the anode reactant or heating the fuel cell stack, the method of disposing a heating plate on the cathode current collector has better economical benefits and more capable of increasing overall electricity generation efficiency of the fuel cell.

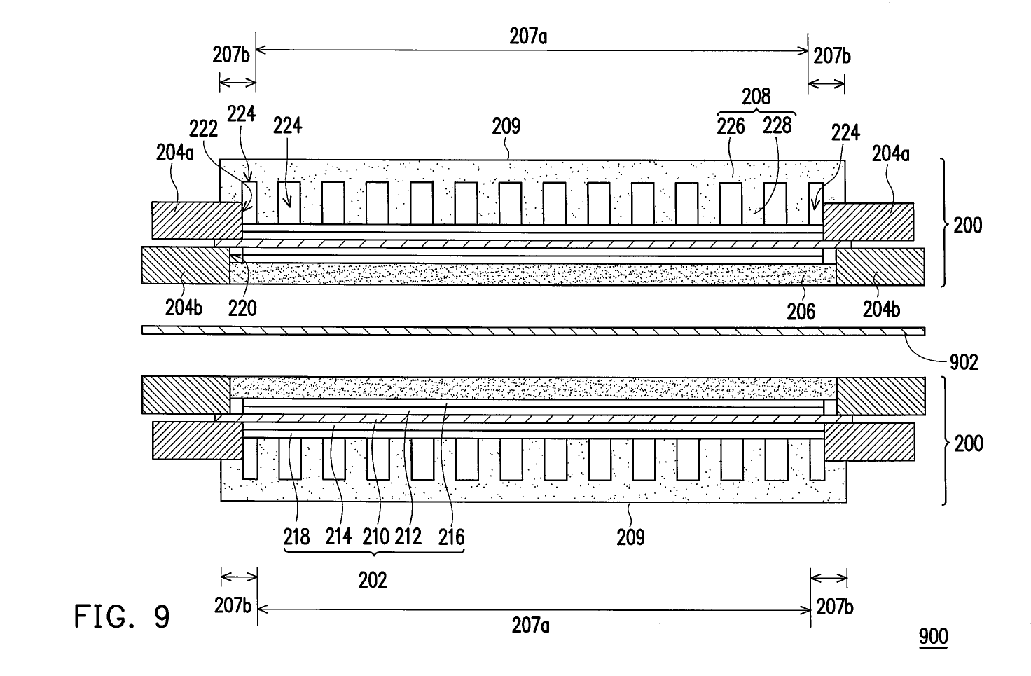

Aside from the fuel cell described in the foregoing embodiments, the present invention is also implemented in other configuration. In FIG. 9, a fuel cell having two fuel cell modules is used as an example in the following description. However, the fuel cell of the present invention may include a stack of fuel cell modules. FIG. 9 is a diagram showing the structure of a fuel cell according to an embodiment of the present invention. The fuel cell 900 includes a stack of two fuel cells of the type already described according to the present invention. In the present embodiment, the fuel cell module 200 in FIG. 2A is used as an example. Moreover, each component uses the same label and duplication of the description is omitted. A separation plate 902 is disposed between the two fuel cell modules 200 of the fuel cell 900. Besides, the anode current collectors 206 of the two fuel cell modules 200 are respectively disposed toward the separation plate 902. The separation plate 902 and the second base plate 204b may be integrally formed or glued together. Additionally, the two surfaces of the separation plate 902 may have flow channel structures to serve as an anode flow channel plate. The flow channel plate is electrically insulated. These flow channel structures increase the assembled strength of the MEA structure. Obviously, a heating plate may also be disposed on the cathode current collector in the present embodiment for heating the MEA and increasing the electricity generation efficiency of the fuel cell.

In summary, the fuel cell as described in the embodiments of the present invention has at least one of, part of or all of the following advantages.

1. The water produced by chemical reaction in the cathode flows out from the edges of the cathode current collector instead of accumulating in the cathode catalyst layer. Therefore, the electricity generation efficiency of the fuel cell is maintained. Besides, the edges of the cathode current collector also allow external air to flow in and out.

2. Because the water draining efficiency of the cathode current collector is better, rotational speed of the fan is reduced to reduce power consumption.

3. When press assembling the fuel cell of the present invention, the compression on the MEA is evenly distributed in order that the MEA has a lower resistance. Moreover, the phenomenon of having residual interfacial stress between the MEA and other additionally used packaging material is improved.

4. The cathode current collector of the fuel cell in the present invention has a larger aperture ratio, and the problem of having insufficient structural strength does not occur. Therefore, the area of reaction between the cathode catalyst layer of the MEA and air (or oxygen) is larger, and the electricity generation capacity of the MEA is increased.

5. The function of the cathode flow channel plate of the present invention is integrated with the cathode current collector. Hence, there is no need to use the cathode flow channel plate in the conventional technique to distribute the airflow evenly. As a result, the fuel cell has a simpler structure, is easy to assemble and occupies a smaller volume.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell, comprising:
at least one fuel cell module, comprising:
a membrane electrode assembly;
a first base plate, having a first opening and disposed on a first side of the membrane electrode assembly, wherein the first opening exposes a central area of the first side of the membrane electrode assembly;
a second base plate, having a second opening and disposed on a second side of the membrane electrode assembly, wherein the second opening exposes a central area of the second side of the membrane electrode assembly, and the first base plate and the second base plate are used to clamp the first side and the second side of the membrane electrode assembly;
an anode current collector, disposed on the second side of the membrane electrode assembly to cover the central area of the second side of the membrane electrode assembly; and
a cathode current collector, disposed on the first side of the membrane electrode assembly and assembled to the first base plate to cover the central area of the first side of the membrane electrode assembly, wherein the cathode current collector extends into the first opening and forms a plurality of flow channels between the cathode current collector and the membrane electrode assembly.

2. The fuel cell according to claim 1, wherein the cathode current collector has a press area located on the first side of the membrane electrode assembly and a fixed area located on two sides of the press area.

3. The fuel cell according to claim 2, wherein the press area of the cathode current collector comprises:
a first bottom plate; and
a plurality of protruding portions, disposed on one side of the first bottom plate and protruding from the side of the first bottom plate toward the membrane electrode assembly, wherein the flow channels is formed between the protruding portions.

4. The fuel cell according to claim 3, wherein the protruding portions are ribs having a equal length and arranged in parallel to one another.

5. The fuel cell according to claim 3, wherein surfaces of the protruding portion close to the membrane electrode assembly are curve surfaces.

6. The fuel cell according to claim 3, wherein the protruding portions are ribs having unequal lengths and arranged in parallel to one another.

7. The fuel cell according to claim 3, wherein the protruding portions are rods arranged in an array.

8. The fuel cell according to claim 3, wherein each of the protruding portions comprises:
a first bent plate, disposed in parallel to the first bottom plate; and
a second bent plate, connected to the first bent plate and the first bottom plate, and perpendicular to the first bottom plate.

9. The fuel cell according to claim 2, wherein the fixed area of the cathode current collector and the press area of the cathode current collector have identical structures.

10. The fuel cell according to claim 2, wherein the fixed area of the cathode current collector and the press area of the cathode current collector have different structures.

11. The fuel cell according to claim 10, wherein the fixed area of the cathode current collector comprises a plurality of through holes.

12. The fuel cell according to claim 10, wherein the fixed area of the cathode current collector comprises:
a second bottom plate; and
a plurality of connecting components, disposed on one side of the second bottom plate for connecting with the first base plate.

13. The fuel cell according to claim 1, wherein the fuel cell module further comprises an insulating material layer coated on a surface of the cathode current collector away from the membrane electrode assembly.

14. The fuel cell according to claim 13, wherein the fuel cell module further comprises a conducting material layer located between the insulating material layer and the cathode current collector.

15. The fuel cell according to claim 1, wherein the fuel cell module further comprises a heating plate disposed on the cathode current collector.

16. The fuel cell according to claim 1, wherein the cathode current collector is connected to the second base plate or the first base plate through soldering, hot pressing, gluing, screw locking or latching.

17. The fuel cell according to claim 1, wherein the second base plate is an anode flow channel plate, the anode current collector is fixed on the anode flow channel plate, and a structure between the anode flow channel plate and the anode current collector allows an anode reactant to flow in and out.

18. The fuel cell according to claim 1, further comprising a separation plate, wherein the fuel cell comprises a stack of fuel cell modules, the separation plate is disposed between every two adjacent fuel cell modules, and the anode current collectors of the fuel cell modules are respectively disposed toward the separation plate.

19. The fuel cell according to claim 18, wherein the separation plate is an anode flow channel plate and the anode flow channel plate is electrically insulated.
